(19) United States
(12) Patent Application Publication
(10) Pub. No.: US 2009/0178889 A1
(43) Pub. Date: Jul. 16, 2009

(54) ELEVATOR SYSTEM

(75) Inventors: Ari HARKONEN, Riihimaki (FI); Sakari KORVENRANTA, Hyvinkaa (FI); Ari KATTAINEN, Hyvinkaa (FI); Timo SYRMAN, Hyvinkaa (FI); Hannu AHRNBERG, Hyvinkaa (FI); Risto JOKINEN, Hyvinkaa (FI)

Correspondence Address: BIRCH STEWART KOLASCH & BIRCH, PO BOX 747, FALLS CHURCH, VA, 22040-0747, US

(73) Assignee: KONE CORPORATION, Helsinki (FI)

(21) Appl. No.: 12/372,486

(22) Filed: Feb. 17, 2009

Related U.S. Application Data
(63) Continuation of application No. PCT/FI2007/000196, filed on Aug. 6, 2007.

(30) Foreign Application Priority Data
Aug. 14, 2006 (FI) 20060727

(51) Int. Cl. B66B 5/06

(52) U.S. Cl. 187/373

(57) ABSTRACT

The invention relates to a safety arrangement of an elevator system and to a method for ensuring safety in an elevator system. The safety arrangement comprises at least one mechanical stopping appliance and the control of the safety arrangement comprises at least one limit value that sets the speed, deceleration or permitted vertical distance from the door zone of the elevator car. In the method for ensuring safety in an elevator system at least one mechanical stopping appliance is fitted to the safety arrangement of the elevator system and at least one limit value that sets the speed, deceleration or permitted vertical distance from the door zone of the elevator car is set for the control of the safety arrangement.

### FIELD OF THE INVENTION

The present invention relates to an elevator system as presented in the preamble of claim 1 and a method for ensuring safety in an elevator system as presented in the preamble of claim 10.

### PRIOR ART

In elevator systems it is important to endeavor to maximize the safety of passengers. The elevator car may not move outside the landing zone when the doors are open, the elevator car may not drop freely at any phase, nor may its movement reach uncontrolled acceleration of movement or uncontrolled deceleration of movement. For this reason elevator appliances contain numerous safety and stopping devices, which take care of the stopping of the elevator car in both normal situations and in fault situations.

The control system of the elevator handles the driving of the elevator from floor to floor. During normal drive, in acceleration and deceleration the control system of the elevator ensures that e.g. the speed of the elevator decreases and that the elevator stops at the right point of the floor. The control system stops the elevator smoothly also at the terminal floor. If normal stopping of the elevator by means of the control system does not work, Normal Terminal Slowdown (NTS) handles the smooth stopping of the elevator at the terminal floor.

If Normal Terminal Slowdown (NTS) does not succeed in stopping the elevator when it arrives at the end of the shaft, ETSL (Emergency Terminal Speed Limiting) stops the elevator by using the machinery brake. The machinery brake is an electromechanical brake, which is generally arranged to connect if necessary to the traction sheave of the elevator. If the deceleration of the elevator is not adequate, ETSL can still use the brake of the elevator car or the wedge brake, i.e. the safety gear, for stopping.

FIG. 1 presents the operation of the safety devices of a modern elevator system. Graph 11 illustrates the travel of the elevator as a function of distance and speed.

A mechanical overspeed governor (OSG) can be used as a safety device. The overspeed governor monitors the speed of the elevator car in the elevator shaft and if the speed of the elevator car exceeds a certain pre-set limit value (e.g. 6 m/s), the overspeed governor disconnects the safety circuit of the elevator, in which case the machinery brake goes on (area 12). The elevator contains a safety circuit, which is cut if any of the switches that are connected to it opens. If the overspeed still increases from the previous, the overspeed governor uses the safety gear (area 16) that is in connection with the elevator car, the wedge of which grips the guide rails of the elevator and prevents the elevator car from sliding. In other words, if the ropes or rope suspensions fail and the elevator car starts to drop freely, the safety gear wedges and grips.

Overspeed can also be monitored electrically. For example, a solution is known from publication WO00/39015, in which an electronic overspeed monitoring appliance receives a signal indicating the speed of the car, compares the speed of the car to the speed limit data stored in the memory of the monitoring appliance, and if necessary produces an activation signal, by means of which the brakes of the elevator can be engaged.

Near the end of the elevator shaft is a final limit switch. The position of the final limit switch is marked x1 in FIG. 1. If the elevator has not stopped before the final limit switch, the safety circuit of the elevator is again cut and the brake of the elevator operates. The final limit switch uses the machinery brake to stop the elevator car (area 12) if the elevator goes e.g. 100 mm past the terminal station.

If the elevator continues onwards a few centimeters from the final limit switch, the car (or correspondingly the counterweight) collides with the buffer 13, which yields and finally stops the elevator. After the buffer there is still an empty space 14, after which the concrete end structure 15 of the shaft is encountered. FIG. 1 presents the shaft structure of especially an elevator system with counterweight. In an elevator without counterweight the buffer structure of the top end of the shaft can be lighter than the one below, because uncontrolled movement can only occur downwards.

Even if the normal control system fails, full-length buffers have a stroke length to the amount that in principle it is safe to drive onto the buffers at full speed, nor does the acceleration inside the car go over the permitted limit before the elevator car stops. Typically 1 g is the kind of acceleration/deceleration that is set in the safety regulations as bearable by a person.

There are also elevator systems in which so-called “reduced stroke buffers” are used. In this case an electrical safety connection is used as an aid in stopping the car. A switch is installed at a certain distance from the end of the shaft, the speed limit of which is e.g. 90% of the nominal speed. A second switch is installed slightly closer to the end of the shaft, the speed limit of which is e.g. 60% of the nominal speed. If the speed is over that permitted at the point of the switch, the safety circuit is again cut and the machinery brake stops the elevator car. If the overspeed still increases from the previous, the safety system of the elevator uses the safety gear in connection with the elevator car to stop the car.

The authorities of different countries have different regulations concerning the safety of elevators. The basic principle is that the elevator must contain the kind of safety system that is able to stop the elevator in a fault situation. For example, according to the elevator directive 95/16/EC issued by the European Union, an elevator must contain an overspeed governor as well as a speed monitoring system. The elevator may not reach uncontrolled acceleration of movement or uncontrolled deceleration of movement. Furthermore, the situation in which the elevator car starts to slide out of the landing zone when the doors are open, owing e.g. to rope slipping or a fault situation in the machinery brake, must be avoided.

### Purpose of the Invention

The purpose of the present invention is to present a new kind of method for ensuring safety in an elevator system, and an elevator system that is safe and reliable. In particular the purpose of the invention is to disclose a method for ensuring safety in an elevator system without counterweight, by means of which it is possible both to prevent unintended movement of the elevator car in the floor zone and an overspeed situation of the elevator car as well as to ensure controlled stopping of the elevator, and an elevator system without counterweight in which stopping of the elevator car is ensured also when prior art safety equipment malfunctions.

### Characteristic Features of the Invention

The elevator system and the method according to the invention are characterized by what is disclosed in the characterization parts of claims 1 and 10. Other embodiments of the invention are characterized by what is disclosed in the other claims. Some inventive embodiments are also discussed in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments can be applied within the scope of the basic inventive concept in conjunction with other embodiments. Furthermore the features that are presented in conjunction with the method according to the invention can be applied in an elevator system according to the invention, and vice versa.

The present invention relates to an elevator system and a method for ensuring safety in an elevator system.

The elevator system according to the invention comprises a safety arrangement as well as the control of the safety arrangement. The safety arrangement according to the invention comprises at least one mechanical stopping appliance and the control of the safety arrangement comprises at least one limit value that sets the speed, deceleration or permitted vertical distance from the door zone of the elevator car. The control of the safety arrangement also comprises the measurement of time, and the limit value of the control of the aforementioned safety arrangement is defined as a function of time.

In one elevator system according to the invention the limit value of the control of the aforementioned safety arrangement is fitted to activate when the operating mode of the elevator system changes.

In one elevator system according to the invention the safety arrangement comprises means for receiving information about the direction of movement, speed and/or deceleration of the elevator car, the status of the safety circuit of the elevator, the status of the machinery brake of the elevator and/or the positioning of the elevator car in the door zone, and monitoring means for monitoring that the vertical distance from the door zone as well as the speed and/or deceleration of the elevator car remain in the range defined by the limit value, and means to control at least one stopping appliance if the vertical distance from the door zone, speed and/or deceleration of the elevator car is outside the permitted range set by the limit value. The safety arrangement further comprises means for setting the operating mode of the elevator system utilizing the information about the direction of movement, speed and/or deceleration of the elevator car, preliminary information about arrival of the elevator in the door zone extrapolated from the status of the safety circuit, information about the status of the machinery brake of the elevator and/or the positioning of the elevator car in the door zone. A limit value, which sets the limit for the permitted minimum deceleration of the elevator car, is connected to at least one operating mode of the elevator system.

The safety arrangement can also comprise means for receiving information about the service drive mode of the elevator and means to set the operating mode of the elevator system utilizing the information about service drive mode, and/or means for measuring time and for storing the time of the switching of the operating mode of the elevator system. Preferably a limit value of the speed and/or minimum deceleration of the elevator car connected to at least one operating mode of the elevator system is defined as a function of time, and a limit value, which sets a limit for the permitted maximum speed of the elevator car, is connected to at least one operating mode of the elevator system. A limit value, which sets the limit for the permitted speed of the elevator car, and at least one second limit value, which sets the limit for the vertical distance of the elevator car from the door zone, can be connected to at least one operating mode of the elevator system.

The elevator system also preferably comprises measuring means for constant measuring of the direction of movement, the speed and/or the deceleration of the elevator car. The means of the elevator system for controlling the stopping appliance can comprise a control switch, for testing the operation of which are further means in the elevator system. In one preferred embodiment the monitoring means are integrated as a part of the control system of the elevator, and the safety arrangement is fitted into the elevator system as supplementary safety, in addition to the machinery brake, the mechanical overspeed monitoring and the limit switches.

In the method for ensuring safety in an elevator system at least one mechanical stopping appliance is fitted to the safety arrangement of the elevator system and at least one limit value that sets the speed, deceleration or permitted vertical distance from the door zone of the elevator car is set for the control of the safety arrangement. In the method the passage of time is measured and at least one limit value of the control of the aforementioned safety arrangement is set as a variable function with respect to time.

In one method according to the invention at least one limit value of the control of the safety arrangement is activated when the operating mode of the elevator system changes.

In one method according to the invention the vertical distance of the elevator car from the door zone, the direction of movement, speed and/or deceleration of the elevator car, the status of the safety circuit of the elevator, the status of the machinery brake of the elevator and/or the positioning of the elevator car in the door zone, is checked, and it is monitored that the vertical distance of the elevator car from the door zone as well as the speed and/or deceleration of the elevator car remain within the permitted range defined by the limit values. If one of the values monitored receives a value outside the permitted range, at least one stopping appliance is controlled. According to the invention the operating mode of the elevator system is set utilizing the information about the direction of movement, the vertical distance from the door zone, the speed and/or the deceleration of the elevator car, preliminary information about arrival of the elevator in the door zone extrapolated from the status of the safety circuit, information about the status of the machinery brake of the elevator and/or the positioning of the elevator car in the door zone, and a limit value, which sets the limit for the minimum deceleration of the elevator car, is connected to at least one operating mode of the elevator system. According to the invention it is also possible to receive information about the service drive mode of the elevator and to set the operating mode of the elevator system utilizing the information about service drive mode. In one preferred embodiment the moment in time when the operating mode of the elevator system changes is stored in memory, the passage of time is measured, and it is monitored that the vertical distance of the elevator car from the door zone as well as the speed and/or deceleration of the elevator car remain within the permitted range defined by the limit values, of which limit values at least one is defined as a function of time. The method can further comprise the following phases: in at least one operating mode it is monitored that the speed of the elevator car remains below a certain maximum speed, in at least one operating mode of the elevator system it as monitored that the speed of the elevator car remains below the permitted speed limit and that the elevator car remains at a permitted distance from the door zone. Preferably the operation of the control switch of the stopping appliance is tested according to the method at regular intervals.

In the following the elevator system and the method of the invention are referred to jointly as the solution according to the invention.

### ADVANTAGES OF THE INVENTION

By means of the solution according to the invention a safe elevator system is achieved. With the solution according to the invention it is possible to avoid hazardous situations produced by undesired movement caused by rope slip or defective machinery brakes, and it is further possible with the solution to ensure that the speed of the elevator remains controlled e.g. in a situation in which dynamic braking does not succeed. With the solution according to the invention it is further possible to ensure success of an emergency stop of the elevator also in fast elevators without counterweight. The safety arrangement incorporated in the elevator system according to the invention can easily be applied for use in conjunction with prior art safety devices, in which case the safety arrangement presented in the invention improves the safety level of the elevator system with few extra components, and in the solution it is possible to utilize the stopping appliances and measuring signals otherwise incorporated in the elevator system.

### PRESENTATION OF DRAWINGS

In the following, the invention will be described in more detail by the aid of one of its embodiments with reference to the attached drawings, wherein

FIG. 1 presents the operation of one safety device according to prior art

FIG. 2 presents a block diagram of the operating modes of the elevator system according to the invention and the switching between them

FIG. 3 presents some limit values of permitted movement according to the invention, which set the limit for the deceleration of the elevator car.

The elevator system according to the invention comprises a safety arrangement as well as the control of the safety arrangement. Preferably the safety arrangement is used as a supplement to prior art safety devices, in which case the safety arrangement presented in the invention stops movement of the elevator car when the safety devices according to prior art for some reason do not operate in the desired manner.

The safety arrangement of the elevator system according to the invention comprises means for receiving and inspecting at least the direction of movement, speed and/or deceleration of the elevator car, the status of the machinery brake of the elevator, the status of the safety circuit of the elevator and the door zone information of the elevator. In elevators without counterweight the machinery brake is typically an asymmetrical brake, which is fitted to brake movement directed downwards with a greater force than movement directed upwards. The safety arrangement further comprises monitoring means, with which it is possible to monitor that the vertical distance of the elevator car from the door zone as well as the speed and/or deceleration of the elevator car remain within the permitted range defined by the limit values of movement, and means for setting the operating mode of the elevator system. According to the invention, by means of the safety arrangement the vertical distance of the elevator car from the door zone as well as the speed and/or deceleration of the elevator car staying within the boundaries of the limit value in certain operating modes of the elevator system is monitored. In different operating modes the movement can be compared to different limit values, and numerous limit values, which are monitored for non-exceedance of their boundaries, can also be connected to a certain operating mode. If the movement of the elevator car is not within the permitted range set by the limit value, at least one stopping appliance is controlled, with which the elevator car can be stopped.

An operating mode of an elevator system in this context means a certain status in which the elevator system can be, and which operating mode is determined by the status of the safety devices and/or actuating devices of the elevator system and/or on the basis of the speed information and/or position information of the elevator car. In the safety arrangement the operating modes to be set do not need to correspond to the other operating modes set for the safety devices or control devices of the elevator system, although they can be the same. For example, the statuses acceleration, uniform speed and braking that are necessary for traffic control can from the viewpoint of the safety arrangement all belong to operating mode 10 “elevator driving”.

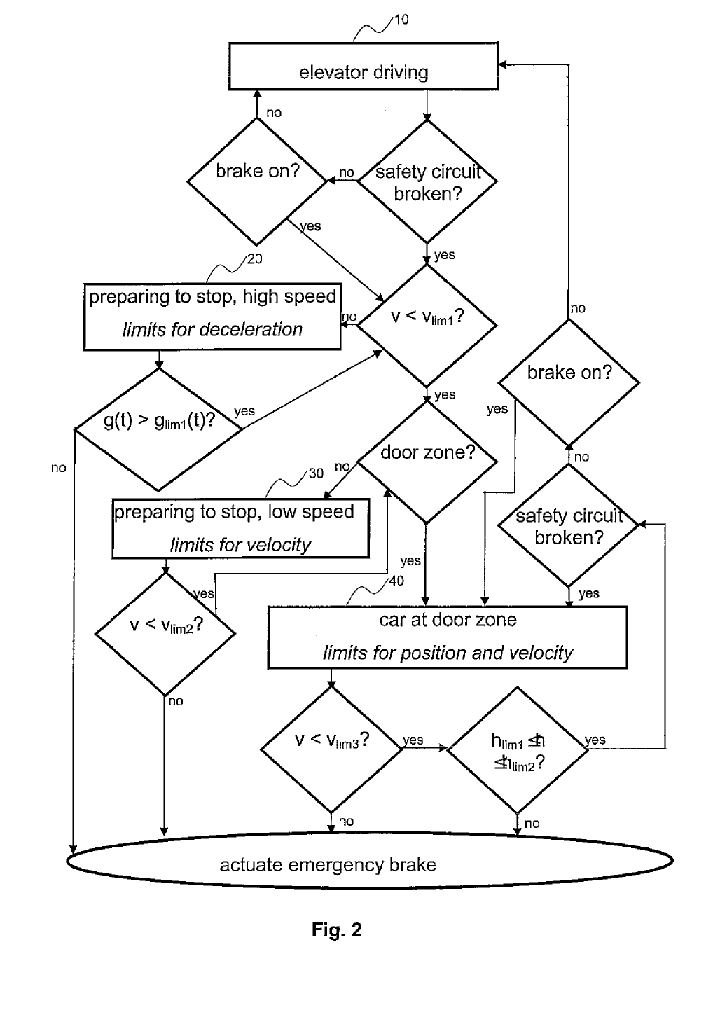

In the following the operation of the safety arrangement is described in conjunction with the operating modes of the elevator system according to FIG. 2 and the method of the safety arrangement for setting the operating mode of the elevator system and for switching from one operating mode to another. In the embodiment the invention is applied in an elevator system without counterweight, in which the safety arrangement comprises means for setting four different operating modes. Different operating modes defined by the means of the safety arrangement, to which one or more supervisory limit values can be connected, can however according to the invention also be more or less than this, and the invention is suited for use also in elevator systems with counterweight.

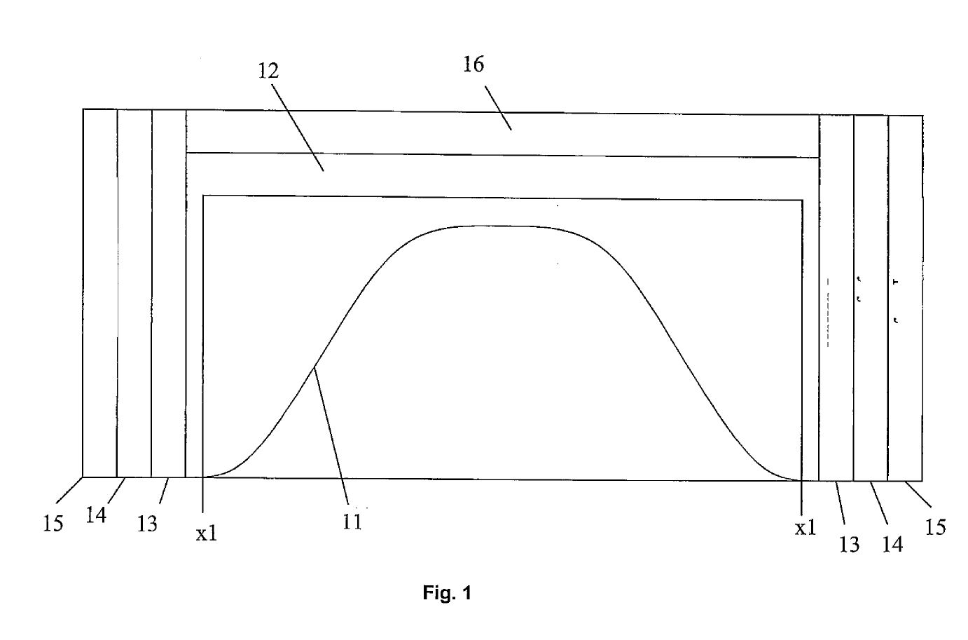

FIG. 2 presents the switching of an elevator system from one operating mode to another as a block diagram. Preferably a movement of the elevator car, such as speed, deceleration and/or position as a function of time, is monitored constantly irrespective of the operating mode of the elevator system, although it is also possible that the safety arrangement is fitted to activate the stopping appliance only in certain operating modes, to which a limit value of the motion is connected, within which defined permitted range the movement of the elevator car must be. It is also possible that a limit value is connected to all the operating modes of the elevator system, compliance with which is monitored and exceedance of the boundaries of which activates a stopping appliance. For example, in the solution according to FIG. 2 the limit curve 11 presented in FIG. 1 could be used in operating mode 10 (elevator driving), i.e. during normal driving of the elevator, which describes the travel of the elevator in the elevator shaft as a function of speed and position, or the electrical safety arrangement according to the invention could be used to replace the mechanical overspeed governor, and a speed limit, which movement of the elevator car may in no circumstances exceed, could be set as the limit value for the mode 10.

In the solution according to FIG. 2, at least information about the status (on/off) of the machinery brake, the status (open/closed) of the safety circuit of the elevator, the door zones and the vertical distance of the elevator car from a door zone are monitored, in addition to the speed and deceleration of the elevator car, which information is monitored preferably constantly. On the basis of the information the operating mode of the elevator system is defined. The safety arrangement preferably also comprises means for measuring time and a memory, in which information about the moment the elevator system switches from one operating mode to another can be stored. The safety arrangement also comprises a memory in which the limit values related to each operating mode of the elevator system is stored.

Door zone information can be obtained e.g. by means of magnets fitted in the elevator shaft in connection with each landing and by means of inductive switches fitted to the elevator car or by means of other sensors suited to conveying door zone information. Information about the movement of the elevator car can be obtained e.g. with a speed sensor such as a pulse encoder or other applicable speed measuring or position measuring method connected to the elevator car, the overspeed governor, or the rope of the overspeed governor. The speed of the elevator car can be calculated from the position information or, when the point of departure is known, the position of the elevator car can be calculated by means of the speed. Further, by means of the speed information it is possible to calculate the acceleration/deceleration of the elevator car, and it is also possible that acceleration sensors for determining deceleration data are connected to the elevator car.

The safety arrangement can comprise means for receiving also other information describing the status of the elevator system. For example, information about the status of the main contactor of the elevator, about the status of the stopping device, such as the switch of the OSG or other anti-creeping appliance and/or the relay controlling this, and/or about manual opening of the machinery brake of the elevator, about the load of the elevator car, or about the status of another switch or actuator connected to the elevator system, can be received and monitored, and these can be utilized in setting the operating mode of the elevator system. Further, it is possible to monitor and utilize also other information in setting the operating mode, such as Information about the speed reference of the elevator, about service drive mode, about inching mode or about another command relating to control of the movements of the elevator.

In FIG. 2 the elevator system has four operating modes detected by the safety arrangement, to three of which a limit value is connected, which sets the limits for permitted movement of the elevator car, within the boundaries of which the movement must remain, and if the movement exceeds the boundaries of which a stopping appliance is activated. The stopping appliance according to the invention can be e.g. a prior art anti-creeping device. It can be e.g. a mechanical catch, guide rail brake or rope brake, which locks directly against the hoisting ropes of the elevator. The stopping appliance used in the solution according to the invention can also be a rope brake, which locks the rope of the overspeed governor in its position, or an appliance that prevents or brakes rotation of the rope pulley of the overspeed governor, in which case when the elevator car moves a little distance downwards, the rope of the overspeed governor activates the safety gear of the elevator and thus prevents creeping of the elevator car downwards, in which case the mechanism that stops the rope of the overspeed governor functions as the stopping appliance, which thus can be formed from e.g. a rope brake or the safety gear.

The safety arrangement checks the operating mode of the elevator system preferably continuously, and when the operating mode of the elevator system changes it switches to compare the movement of the elevator car to the limit value corresponding to the new operating mode. During normal driving 10 of the elevator (elevator driving) the status of the safety circuit and of the machinery brake is monitored. If the brake engages and the safety circuit opens, it is interpreted as the end of elevator driving. If there is no fault situation in the elevator system, the actual situation is one in which the elevator car is arriving at a landing. Before the elevator system is interpreted as having switched to mode 40 “car at door zone”, the direction of movement and the speed of the elevator car are checked. The directions of the magnitudes presented in FIG. 2 are defined such that the positive direction of the speed v is downwards, and the deceleration g is positive when the elevator car moves downwards at a decelerating speed.

If the elevator car is moving downwards and the speed is more than the set limit speed vₗᵢₘ₁, the elevator system is interpreted as having switched to the operating mode 20 (preparing to stop, high speed), in which the elevator is being stopped from a fast speed, e.g. because of a fault situation. If the elevator car is moving upwards or its speed when moving downwards is at the highest vₗᵢₘ₁, it is checked whether information about the positioning of the elevator car in the door zone has been received from the elevator. If the door zone information indicates that the elevator car is in the door zone, operating mode 40 ‘car at door zone’ is set. If the elevator car is not in the door zone, it is determined that the elevator system has switched to the operating mode 30, in which the elevator is being stopped from a slow speed (preparing to stop, low speed).

When the elevator system is in the operating mode 20, (elevator preparing to stop, high speed), the circumstance can be e.g. a situation in which the elevator car is being stopped by means of ETSL. The objective is in this case to stop the elevator by using different stopping appliances such that the elevator car is brought to a stop reliably and quickly. It is not desirable, however, that the stopping appliance used according to the invention is switched on when the elevator is at full speed unless this is unavoidable, but rather in the safety arrangement according to the invention the stopping appliance is activated only if and when the other safety systems and stopping appliances incorporated in the elevator system do not produce sufficient deceleration for the elevator car. Especially in fast elevators without counterweight it is not desirable that the elevator car ends up being stopped e.g. by the safety gear when its speed is too great, because deceleration that is too great causes a risk to both the wellbeing of the passengers and to the operation of the stopping appliance itself.

The safety arrangement according to the invention is thus applicable for use as additional safety as a supplement to prior art safety devices. It is however possible that other safety devices are replaced with the solution according to the invention.

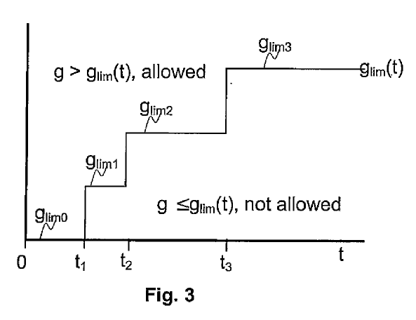

The limit values connected to the operating mode 20 set the limit for the deceleration that at minimum the elevator car must have. Preferably the limit values are defined as a function of time, e.g. in the manner described in FIG. 3. When the elevator system switches to mode 20, the moment of time when the switching occurs as well as the speed of the elevator car at the moment of switching is recorded in the memory. After this the deceleration of the elevator car is calculated as a function of time and it is monitored that the requirements set by the limit value for movement of the elevator car are fulfilled. Here the range of permitted movement is an area above the limit value, in which the deceleration exceeds the limit gₗᵢₘ(t), and the gₗᵢₘ(t) on the curve and the area below it, in which the deceleration is gₗᵢₘ(t) or less than it, causes activation of the stopping appliance.

In FIG. 3 the moment t=0 describes the moment when the elevator system has switched to the operating mode 20. Between t=0 . . . t₁ the limit value gₗᵢₘ₀ set for deceleration is zero, because deceleration is not needed just when the elevator system has switched to the operating mode 20. Between t₁ . . . t₂ deceleration has the limit value gₗᵢₘ₁, between t₂ . . . t₃ the limit value of deceleration is gₗᵢₘ₂ and after the moment t₃ the limit value is gₗᵢₘ₃. Preferably gₗᵢₘ₃>gₗᵢₘ₂>gₗᵢₘ₁>gₗᵢₘ₀ qualify for limit values, in which case it is possible to give to other safety devices, such as to the machinery brake, time to stop the movement of the elevator car in a controlled manner, and to use the stopping appliance of the safety arrangement according to the invention only in fault situations of other systems or e.g. when the ropes slip in conjunction with an emergency stop. In elevators that move slowly, e.g. 0.6 m/s, success of an emergency stop could be ensured by using a simple time delay, after which the stopping appliance is activated. Purely using a time delay in activating the stopping appliance would not however produce the desired result in fast elevators (speed e.g. 6 m/s) without counterweight, because with prior art stopping appliances a time of some seconds is spent on stopping movement of the elevator car, and the time delay could not be set large enough to prevent the speed of the elevator car growing excessively, if e.g. the machinery brake is defective. According to the invention with a deceleration limit value defined to grow as a function of time it is possible to ensure a safe emergency stop of the elevator car.

In mode 20 also the speed and the direction of the elevator car are constantly monitored and compared to the speed limit vₗᵢₘ₁. In this embodiment the limit values for speed and deceleration are set only for movement directed downwards, but according to the invention it is however possible to set limits also for movement directed upwards. If the speed decreases below the value vₗᵢₘ₁ with sufficient deceleration, it is checked whether the elevator car is in the door zone, and depending on the door zone information the elevator system is determined to be either in the operating mode 30 or in the operating mode 40.

When movement of the elevator car occurs upwards or if the speed downwards is small, below vₗᵢₘ₁, there is a switch to mode 30 (elevator preparing to stop, low speed), in which the speed of the elevator car is monitored comparing it to the limit value that sets the speed limit. The limit value vₗᵢₘ₂ of the greatest permitted speed connected to the operating mode 30 sets the speed limit below which the state of movement of the elevator is permitted at lower speeds. When the speed is vₗᵢₘ₂ or greater than this, the stopping appliance is activated. In addition, the velocity and the door zone information of the elevator car is monitored for setting the switching to the next operating mode. When the elevator system is in the operating mode 30, what is occurring can be e.g. a fault situation, in which the electricity supply of the elevator system is defective, and the speed of the elevator is restricted e.g. by means of dynamic braking of the motor, or e.g. in the final stage of ETSL stopping. Further, it is possible that what is occurring is an emergency stop in movement directed upwards, which in an elevator without counterweight is, in itself, easy to implement when gravity is pulling the elevator car downwards, but in which there can be a risk of the brake slipping after the emergency stop. In mode 30 it is monitored with the safety arrangement that the brake does not start to slip downwards after a successful emergency stop. Thus in the operating mode 30 of the elevator system according to the invention, the stopping appliance is activated if the speed of the elevator car exceeds the permitted limit, e.g. when dynamic braking does not succeed, or if the ropes of the elevator slip—i.e. the friction between the traction sheave and the hoisting roping is not sufficient to keep the elevator on the desired path.

When the elevator is verified as having moved to the door zone, i.e. into operating mode 40 (car at door zone), comparison of the movement of the elevator car to both the speed limit and the position limits is started. In the door zone it is ensured that the speed of the elevator car is not able, e.g. owing to rope slip or failure of the brakes, to exceed the permitted speed. It is further monitored in the door zone that the elevator car stays in the door zone, or that it leaves the door zone by at the most the permitted distance. The distance can be calculated when the information about the moment when the elevator car leaves the door zone is recorded, and the speed of the elevator car is monitored constantly. In the example according to FIG. 2 the speed of the elevator car is compared to the same limit values irrespective of whether the doors of the elevator car are open or closed, and whether the elevator is on the inching drive setting or not. According to the invention it is possible, however, that separate operating modes are set for these. Thus three limit values of movement are connected to the operating mode 40: the limit value vₗᵢₘ₂ sets the speed limit, below which the state of movement of the elevator is permitted at lower speeds, and the limit values hₗᵢₘ₁ and hₗᵢₘ₂ set the limit for the permitted distance of the elevator car from the door zone. The permitted position h is between these, i.e. when hₗᵢₘ₁≦h≦hₗᵢₘ₂.

FIG. 2 presents the safety arrangement especially of an elevator system without counterweight, in which uncontrolled accelerating movement can only occur downwards. When using the solution according to the invention in an elevator system with counterweight, in which a fault situation can cause uncontrolled movement of the elevator car either downwards or upwards depending on the state of loading of the elevator car, the criteria for making a decision about switching from one operating mode to another and/or setting the operating modes of the elevator system in the safety arrangement are preferably formed such that the speed and the deceleration are monitored and limit values are set for movement directed both upwards and downwards. It is possible that the limit values are set to be the same for the magnitudes directed upwards and directed downwards, but these can also differ from each other.

FIG. 2 presents the operation of an elevator system according to the invention and of its safety arrangement with the aid of a simple embodiment. The safety arrangement according to the invention can however comprise means for setting also other operating modes of the elevator system. In one preferred embodiment the safety arrangement comprises means for receiving information about the manual opening of the machinery brake, and in this case the machinery brakes can be opened manually such that the safety arrangement does not activate the stopping appliance, in which case the elevator car can drive to a floor also when the electrical circuits are disconnected. The safety arrangement can further comprise means for testing the operation of the control switch of the stopping appliance and for resetting the memory of a safety device e.g. after malfunctioning of the elevator system. In one preferred embodiment the operation of the control switch of the stopping appliance is tested at regular intervals, e.g. once a day or after the 50th run.

The means for receiving information and for monitoring movement that are incorporated in the arrangement according to the invention can be implemented with a software program in conjunction with the control system of the elevator such that for implementing the safety arrangement mainly a switch must be added to the elevator control system according to prior art for an elevator system, with which switch the stopping appliance can be activated when the output of the control means so sets it. A prior art stopping appliance can be used as a stopping appliance, which is fitted to operate also when controlled by a safety device other than one according to the invention, e.g. a safety gear functioning as the stopping appliance of a mechanical overspeed governor.

By means of the solution presented in FIG. 2 it is possible to implement at least the following safety procedures: when the elevator car is situated in the door zone either in normal mode or in inching mode, the stopping appliance is activated if the elevator car moves away from the proximity of the door area or if the speed of the elevator car is too great The stopping appliance is activated in an emergency stop downwards if the deceleration is not adequate, and in an emergency stop upwards if the speed of the elevator car after stopping tries to increase below the permitted limit. If the electricity of the elevator is disconnected during a run, it is attempted to stop or limit movement of the elevator car with the safety devices, and the stopping appliance of the solution according to the invention is activated only if needed when the deceleration remains too small.

By means of the safety arrangement according to the invention it is also possible to implement the following functions: the means for controlling the stopping appliance can be fitted to switch off when the machinery brake is opened manually, in which case when the elevator car comes to a standstill outside the door area it can be driven away without the stopping appliance of the safety arrangement stopping elevator car. In order to implement this, a switch can be fitted in connection with the machinery brake, which indicates the manual opening of the brake, and the safety arrangement can comprise means for receiving information about the status of this switch. The safety arrangement can also be fitted to enable manual rescue both during an electricity power cut and also when electricity is available.

It is obvious to the person skilled in the art that the invention is not limited solely to the example described above, but that it may be varied within the scope of the claims presented below. It is also obvious to a person skilled in the art that the functional parts of the aforementioned safety arrangement do not necessarily need to be separate but they can be integrated directly into the control system of the elevator. The limit values of permitted movement connected to the different operating modes can be stored in the memory of the means incorporated in the safety arrangement. In one preferred embodiment, the safety arrangement according to the invention is implemented in connection with the control unit of the frequency converter incorporated in the electricity supply equipment of the elevator, which in prior art also is fitted to receive information, which is used in the safety arrangement to set the operating mode of the elevator system. In this case no additional components at all are necessarily needed alongside the prior art safety devices to implement the safety appliance according to the invention, and the physical additional components needed can be restricted to e.g. a relay, with which the stopping appliance can be activated.

The invention is not limited to the embodiments described above, in which the invention is described using examples, but rather many adaptations and different embodiments of the invention are possible within the scope of the inventive concept defined by the claims presented below.

1. Elevator system, which incorporates a safety arrangement and a control of the safety arrangement, in which the safety arrangement comprises at least one mechanical stopping appliance and in which the control of the safety arrangement comprises at least one limit value that sets the speed, deceleration or permitted vertical distance from the door zone of the elevator car, wherein the control of the aforementioned safety arrangement comprises the measurement of time and in that the limit value of the control of the aforementioned safety arrangement is defined as a function of time.

2. Elevator system according to claim 1, wherein the limit value of the control of the aforementioned safety arrangement is fitted to activate when the operating mode (10, 20, 30, 40) of the elevator system changes.

3. Elevator system according to claim 1, wherein the safety arrangement comprises means for receiving information about the direction of movement, speed and/or deceleration of the elevator car as well as its vertical distance from the door zone, the status of the safety circuit of the elevator, the status of the machinery brake of the elevator and/or the positioning of the elevator car in the door zone, and monitoring means for monitoring that the speed and/or deceleration as well as its vertical distance from the door zone remain in the permitted range set by the limit values, and means to control at least one stopping appliance if the speed and/or deceleration of the elevator car as well as its vertical distance from the door zone, are outside the permitted range set by the limit values, and ill that the safety arrangement comprises means for setting the operating mode (10, 20, 3 0) of the elevator system utilizing information about the speed and/or deceleration of the elevator car, the status of the machinery brake of the elevator and/or the positioning of the elevator car in the door zone, and in that a limit value is connected to at least one operating mode of the elevator system, which sets the limit for the permitted minimum deceleration of the elevator car, and in that the safety arrangement comprises means for setting the operating mode (10, 20, 30) of the elevator system utilizing information about the direction of movement of the elevator car, the vertical distance of the elevator car from the door zone as well as preliminary information about arrival in the door zone extrapolated from the status of the safety circuit of the elevator.

4. Elevator system according to claim 1, wherein the safety arrangement comprises means for receiving information about the service drive mode of the elevator and means to set the operating mode of the elevator system utilizing the information about service drive mode.

5. Elevator system according to claim 1, wherein a limit value, which sets the limit for the permitted maximum speed of the elevator car, is connected to at least one operating mode of the elevator system.

6. Elevator system according to claim 1, wherein a limit value, which sets the limit for the permitted speed of the elevator car, and at least one second limit value, which sets the limit for the vertical movement of the elevator car in the proximity of the door zone, is connected to at least one operating mode of the elevator system.

7. Elevator system according to claim 1, wherein the elevator system also comprises measuring means for continuously measuring the movement information of the elevator car.

8. Elevator system according to claim 1, wherein the means of the elevator system for controlling the stopping appliance comprise a control switch, and in that the elevator system her comprises means for testing the operation of the control switch.

9. Elevator system according to claim 1, wherein the monitoring means are integrated as a part of the control system of the elevator.

10. Elevator system according to claim 1, wherein the safety arrangement is fitted into the elevator system as supplementary safety, in addition to the machinery brake, the mechanical overspeed monitoring and the limit switches.

11. Method for ensuring safety in an elevator system, in which method:
at least one mechanical stopping appliance is fitted to the safety arrangement of the elevator system
at least one limit value that sets the speed, deceleration or permitted vertical distance from the door zone of the elevator car is set for the control of the safety arrangement. wherein:
the passage of time is measured
at least one limit value of the control of the aforementioned safety arrangement is set as a variable function with respect to time

12. Method according to claim 11, wherein:
at least one limit value of the control of the safety arrangement is activated when the operating mode (10, 20, 30, 40) of the elevator system changes

13. Method according to claim 11, wherein:
the direction of movement, speed and/or deceleration of the elevator car as well as its vertical distance from the door zone, the status of the safety circuit of the elevator, the status of the machinery brake of the elevator and/or the positioning of the elevator car in the door zone is checked
it is monitored that the speed and/or deceleration of the elevator car as well as its vertical distance from the door zone remain within the permitted range defined by the limit values and at least one stopping appliance is controlled if the movement of the elevator car is outside the permitted range set by the limit values
the operating mode of the elevator system is set utilizing the information about the direction of movement, speed and/or deceleration of the elevator car, as well as about the vertical distance from the door zone, preliminary information about arrival of the elevator in the door zone extrapolated from the status of the safety circuit, information about the status of the machinery brake of the elevator and/or the positioning of the elevator car in the door zone
in at least one operating mode it is monitored that the deceleration of the elevator car remains within the permitted range set by the limit value of movement, which limit value sets the limit for the permitted minimum deceleration of the elevator car.

14. Method according to claim 11, wherein:
information about the service drive mode of the elevator is received and the operating mode of the elevator system is set utilizing the information about service drive mode

15. Method according to claim 11, wherein:
it is monitored that the speed of the elevator car remains within the permitted range set by the limit value of movement, which limit value sets the limit for the permitted maximum speed of the elevator car.

16. Method according to claim 11, wherein:
it is monitored that in at least one operating mode of the elevator system the speed of the elevator car remains within the permitted range set by the limit value, which limit value sets the limit for the permitted speed of the elevator car, and in addition to this at least the position of the elevator car in the elevator shaft is monitored such that vertical movement of the elevator car in the proximity of the door zone remains within the permitted range set by the limit value.

17. Method according to claim 11 wherein the means of the elevator system for controlling the stopping appliance comprise a control switch, and in that the method further comprises the phase: the operation of the control switch is tested at regular intervals.

18. Elevator system according to claim 2, wherein the safety arrangement comprises means for receiving information about the direction of movement, speed and/or deceleration of the elevator car as well as its vertical distance from the door zone, the status of the safety circuit of the elevator, the status of the machinery brake of the elevator and/or the positioning of the elevator car in the door zone, and monitoring means for monitoring that the speed and/or deceleration as well as its vertical distance from the door zone remain in the permitted range set by the limit values, and means to control at least one stopping appliance if the speed and/or deceleration of the elevator car as well as its vertical distance from the door zone, are outside the permitted range set by the limit values, and hi that the safety arrangement comprises means for setting the operating mode (10, 20, 30) of the elevator system utilizing information about the speed and/or deceleration of the elevator car, the status of the machinery brake of the elevator and/or the positioning of the elevator car in the door zone, and in that a limit value is connected to at least one operating mode of the elevator system, which sets the limit for the permitted minimum deceleration of the elevator car, and in that the safety arrangement comprises means for setting the operating mode (10, 20, 30) of the elevator system utilizing information about the direction of movement of the elevator car, the vertical distance of the elevator car from the door zone as well as preliminary information about arrival in the door zone extrapolated from the status of the safety circuit of the elevator.

19. Elevator system according to claim 2, wherein the safety arrangement comprises means for receiving information about the service drive mode of the elevator and means to set the operating mode of the elevator system utilizing the information about service drive mode.

20. Elevator system according to claim 3, wherein the safety arrangement comprises means for receiving information about the service drive mode of the elevator and means to set the operating mode of the elevator system utilizing the information about service drive mode.
